(19) United States
(12) Patent Application Publication
(10) Pub. No.: US 2015/0309572 A1
(43) Pub. Date: Oct. 29, 2015

(54) APPARATUS AND METHOD FOR IMPLEMENTING P300 COMPONENT-BASED BRAIN-COMPUTER INTERFACE

(71) Applicant: Samsung Electronics Co., Ltd., Suwon-si (KR)

(72) Inventor: Jinhe SHI, Hangzhou City (CN)

(21) Appl. No.: 14/693,297

(22) Filed: Apr. 22, 2015

(30) Foreign Application Priority Data
Apr. 28, 2014 (CN) 201410175100.8
Dec. 11, 2014 (KR) 10-2014-0178712

(51) Int. Cl. G06F 3/01

(52) U.S. Cl. CPC G06F 3/015

(57) ABSTRACT

An apparatus, system and method for implementing a P300 component-based BCI are provided. The apparatus may include a display unit to display to a user the P300 component-based BCI, which includes a plurality of items to be selected, an item division unit to divide the plurality of items into N subsets according to usage frequencies of respective items, wherein N is an integer larger than 1, wherein a higher usage frequency the item has, a smaller subset the item belongs to, and a flashing unit to cause N items in the BCI to illuminate each time in a desired (and/or predetermined) frequency so as to make the user aware of, or feel, flashing of the respective items, wherein one item may be randomly selected from each of the subsets to constitute the N items.

### CROSS-REFERENCE TO RELATED APPLICATIONS

This application claims the benefit of Korean Patent Application No. 10-2014-0178712, filed on Dec. 11, 2014, in the Korean Intellectual Property Office, and Chinese Patent Application No. 201410175100.8, filed on Apr. 28, 2014, in the State Intellectual Property Office of the People's Republic of China, the disclosures of each of which are incorporated herein in their entirety by reference.

### BACKGROUND

1. Field

Some example embodiments relate to a brain-computer interface (BCI) technologies, and more particularly, to an apparatus and method for implementing a P300 component-based BCI and an apparatus and method for the P300 component-based BCI.

2. Description of Related Art

BCI aims to transform brain activity during thinking to a control signal for a peripheral device. A typical BCI system is composed of three parts—a data collection part, a signal processing part and a control part. The data collection part is connected to a brain directly so as to be responsible for collecting a signal of neurological activity in the brain. The signal processing part, as a core part of the BCI system, analyzes the collected signal, recognizes the brain's intent and transforms it into a control instruction, where the quality of the signal processing may directly impact the performance of the system. The control part operates the peripheral device according to the control instruction to accomplish certain functions such as a computer input, a wheelchair control and a mechanical arm control, which are also the functions ultimately realized by the BCI system.

### SUMMARY

Some example embodiments provide an apparatus, system and/or method for implementing a P300 component-based BCI which may shorten the recognition time and improve the recognition speed.

According to an example embodiment, there may be provided an apparatus for implementing a P300 component-based brain-computer interface (BCI), the apparatus may include a display unit configured to display to a user a P300 component-based BCI, which includes a plurality of items to be selected, an item division unit configured to divide the plurality of items into at least two N subsets according to usage frequencies of each of the plurality of items, wherein the higher usage frequency the item may have, the smaller subset the item may belong to, and a flashing unit configured to cause N items in the BCI to illuminate in accordance with a desired frequency in order to cause at least one flashing of the N items, and the flashing unit configured to randomly select a respective item from each of the N subsets to constitute the N items.

The randomly selected items may be at least one of a character, icon and thumbnail.

The item division unit may include a frequency table acquisition module configured to acquire a usage frequency table of the plurality of items where the plurality of items are ranked based on the usage frequencies of the N items in a descending order, and a division module configured to divide the plurality of items into a first through N-th subsets in turn according to a ranking in the usage frequency table, wherein each subset of the first through N-th subsets contains the same or greater number of items as the previous subset.

The items to be selected may be characters and the frequency table acquisition module may be configured to acquire a usage frequency table corresponding to an input environment of the characters.

The input environment of the characters may include support for one or more languages, such as a Chinese-language input environment, an English-language input environment, or any other language input environment.

The flashing unit may include an item selection module configured to randomly select the respective item from each of the first through N-th subsets to constitute the N items for illumination, wherein an i-th subset may be one of the first through N-th subsets, wherein i=1, . . . , N, and the i-th subset may be composed of Mi items, and wherein Mi may be an integer larger than 1, wherein the item selected from the i-th subset may be different each time for each Mi selection performed since an item may be selected from the i-th subset for a first time, and an illuminating module configured to cause the N items selected by the item selection module in the BCI to illuminate in accordance with a desired frequency so as to cause the at least one flashing of the N items.

According to another example embodiment, there may be provided an apparatus for a P300 component-based brain-computer interface (BCI), including an acquisition unit configured to acquire an electroencephalogram (EEG) signal of the user in response to each flashing, a recognition unit configured to recognize the item which the user desires to select, based on the P300 component in the acquired EEG signal, and a control unit configured to perform a corresponding control operation according to the recognized item.

The recognition unit may include a P300 component acquisition module configured to acquire the P300 component in the EEG signal of the user in response to each flashing, an accumulation module configured to accumulate the P300 component collected with respect to the each flashing, the P300 components corresponding to the N items that were flashing, and a determination module configured to determine one item of the N items that were flashing as corresponding to a largest accumulated P300 component, and in accordance with the determining, recognizing the one item of the N items that were flashing as the item which the user desires to select.

The apparatus may further include an updating unit configured to update the usage frequencies of the respective items based on the recognized item.

The control operation may be configured to include at least one of inputting a content corresponding to the recognized item, executing an application corresponding to the recognized item, and performing a process corresponding to the recognized item.

According to another example embodiment, there may be provided a method for implementing an P300 component-based brain-computer interface (BCI), including displaying to a user the P300 component-based BCI, which may include a plurality of items to be selected, dividing the plurality of items into at least two N subsets according to usage frequencies of respective items, wherein a higher usage frequency the item may have, a smaller subset the item may belong to, and causing N items in the BCI to illuminate according to a desired frequency so as to cause flashing of N items, wherein one item may be randomly selected from each of the N subsets to constitute the N items.

The dividing of the plurality of items may include acquiring a usage frequency table of the plurality of items where the plurality of items are ranked based on the usage frequencies of the items in a descending order, and dividing the plurality of items into a first through N-th subsets in turn according to a ranking in the usage frequency table, wherein each subset has an increasing size from the first subset to the N-th subset.

The items to be selected may be characters and the acquired usage frequency table may correspond to an input environment of the characters.

The input environment of the characters may include a Chinese input environment and/or an English input environment, or any other language.

The causing of the N items in the BCI to illuminate may include randomly selecting the item from each of the first through N-th subsets to constitute the N items for illumination, wherein an i-th subset may be one of the first through N-th subsets composed of Mi items, wherein Mi may be an integer larger than 1 and i=1, . . . , N, wherein the item selected from the i-th subset may be different from one another for Mi selections performed since an item may be selected from the i-th subset for a first time, and causing the selected N items in the BCI to illuminate each time in the desired frequency so as to cause the flashing of the N items.

According to another example embodiment, there may be provided a method for a P300 component-based BCI further including acquiring an electroencephalogram (EEG) signal of the user in response to each flashing, recognizing the item which the user desires to select, based on the P300 component in the acquired EEG signal, and performing a corresponding control operation according to the recognized item.

The recognizing of the item may include acquiring the P300 component in the EEG signal of the user in response to each flashing, accumulating the P300 component collected with respect to the each flashing, the P300 components corresponding to the N items which are caused to illuminate for said each flashing, and determining the item corresponding to a largest accumulated P300 component as the item which the user desires to select.

The method may further include updating the usage frequencies of the respective items based on the recognized item.

The performing of the corresponding control operation may include causing at least one of inputting a content corresponding to the recognized item, executing an application corresponding to the recognized item, and performing a process corresponding to the recognized item.

According to another example embodiment, a brain-computer interface (BCI) system may comprise an electroencephalography (EEG) collection device connected to a user, the EEG collection device configured to collect EEG signals produced by the user, a display configured to display images to a user, the images corresponding to a user interface environment, a processor configured to separate the images into a plurality of categories, present at least one image from each of the plurality of categories to the user on the display panel, and to cause the presented images to flash, and the processor is configured to determine the image that the user has selected based on the collected EEG signals after the flashing unit has presented the at least one image to the user, and perform an action based on the image that the user has selected.

The user interface environment may further correspond to a virtual keyboard for a language and the images may correspond to characters of the language.

The user interface environment may correspond to a plurality of programs that the processor may be configured to execute and the images may correspond to icons for the plurality of programs.

The user interface environment may correspond to a user interface for control of an electrical device and the images may correspond to actions that the electrical device may be configured to perform.

Additional aspects and/or advantages will be set forth in part in the description which follows and, in part, will be apparent from the description, or may be learned by practice of the example embodiments.

### BRIEF DESCRIPTION OF THE DRAWINGS

The foregoing and other features of some example embodiments will be apparent from the more particular description of non-limiting embodiments, as illustrated in the accompanying drawings in which like reference characters refer to like parts throughout the different views. The drawings are not necessarily to scale, emphasis instead being placed upon illustrating principles of example embodiments. In the drawings:

FIG. 1 illustrates a block diagram of an apparatus for implementing a P300 component-based BCI according to an example embodiment;

FIG. 2 illustrates a block diagram of an item division unit according to an example embodiment;

FIG. 3 illustrates a block diagram of a flashing unit according to an example embodiment;

FIG. 4 illustrates a flow diagram of a method for implementing a P300 component-based BCI according to an example embodiment;

FIG. 5 illustrates a block diagram of an apparatus for a P300 component-based BCI according to an example embodiment;

FIG. 6 illustrates a block diagram of a recognition unit according to an example embodiment;

FIG. 7 illustrates a flow diagram of a method for a P300 component-based BCI according to an example embodiment;

FIG. 8 illustrates a flow diagram of a method for recognizing an item which the user desires to select based on a P300 component in an acquired EEG signal according to an example embodiment.

### DETAILED DESCRIPTION

Some example embodiments will now be described more fully with reference to the accompanying drawings. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In a conventional electroencephalogram (EEG)-based BCI system, the most common EEG signals include visually evoked potentials, slow cortical potentials, motor imagery potentials and P300 components in event-related potentials. The P300 components in event-related potentials are endogenously evoked potentials corresponding to a test subject's attention. The P300 component generally is observed approximately 300 ms after a stimulus has been presented to the test subject. The P300 components have some advantages, for example, the P300 components have time-domain waveform characteristics, and can be generated stably without training the test subject. Therefore, the P300 components are mainly used in experiments where characters are input into a BCI as stimuli for the test subject.

Stimuli may be provided to create an “Oddball” condition for the generation of the P300 components. The Oddball condition may include presenting two different types of stimuli to a test subject. One of the stimuli types has a high probability of occurrence and is called the standard stimulus, and the other of stimuli has a low probability and is thus called a deviant stimulus. Both stimuli types apply to the same sensory modality (e.g., they are both visual stimuli). The two types of stimuli are presented in a random order. The deviant stimulus occurs by chance for the tester. During the test, the tester pays attention to the deviant stimuli and the P300 components may be observed during the study of the test subject's EEG when the random low-probability deviant stimulus is presented to the test subject. The lower the probability a deviant stimulus is, the larger the potential amplitude of a single P300 observed. The waveform of the P300 components may appear to be more obvious after being accumulated more than one time.

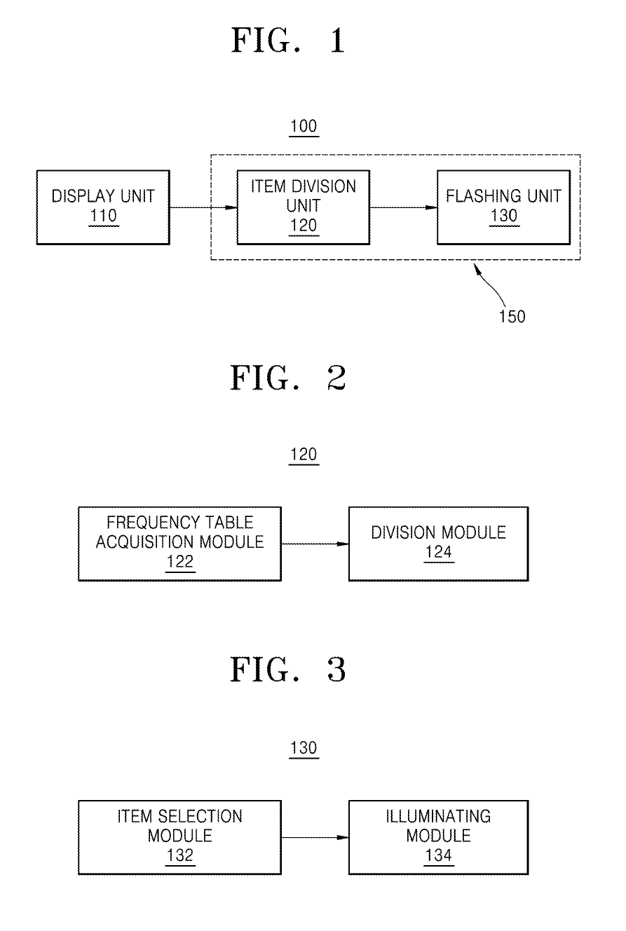

FIG. 1 illustrates a block diagram of an apparatus 100 for implementing a P300 component-based BCI according to an example embodiment. Here, as an example, the apparatus 100 may be implemented using various display apparatuses (e.g., a cell phone display, a computer display, a TV display and so on), projectors or the like for implementing the P300 component-based BCI.

As illustrated in FIG. 1, the apparatus 100 for implementing the P300 component-based BCI according to an example embodiment may include a display unit 110, and a processor 150. The processor 150 may include an item division unit 120 and a flashing unit 130. Alternatively, the item division unit 120, and/or the flashing unit 130 may be implemented as specialized hardware devices that communicatively connected to the processor 150, such as by a communication bus or a wireless connection. While only one processor is illustrated in FIG. 1, the apparatus 100 is not limited thereto, and may include a plurality of processors and one or more data storage devices (not shown). The one or more processors may be special purpose computer processing devices configured to carry out program code stored in the one or more storage devices by performing arithmetical, logical, and input/output operations. For example, program code, software units, and/or software modules may be loaded into the one or more processors. Once the program code and/or software modules are loaded into the one or more processors, the one or more processors may be configured to perform operations according to various example embodiments.

The one or more storage devices may be a computer readable storage medium that generally includes a random access memory (RAM), read only memory (ROM), a permanent mass storage device (such as a disk drive), and/or any other like data storage mechanism capable of storing and recording data. The one or more storage devices may be configured to store program code for one or more operating systems and/or program code for one or more software components and/or modules for performing operations according to various example embodiments. These software components may also be loaded from a separate computer readable storage medium into the one or more storage devices and/or the one or more processors using a drive mechanism (not shown). Such separate computer readable storage medium may include memory card, removable flash memory drive, and/or other like computer readable storage medium (not shown). In some embodiments, software components may be loaded into the one or more storage devices and/or the one or more processors from a remote data storage device via a network interface, rather than via a computer readable storage medium.

The display unit 110 may be used to display to a user the P300 component-based BCI, which may include a plurality of items to be selected.

The display unit 110 may display to the user the P300 component-based BCI through a screen, display panel, projector, or the like. The user may select one item from the BCI by watching the item. The item may be a character, an icon, a thumbnail, or the like. In other words, the item may be an image, or pictorial representation, presented to the user that may correspond to an idea, expression, character, number, action, object, or the like, that the user may focus on to provide the BCI with an indication of what the user desires. For example, the BCI may be a virtual keyboard interface including a plurality of characters with which the user may indicate which characters the user wishes to write, a user interface (UI) including a plurality of application icons with which the user may indicate which application the user wishes to execute, or the like.

The item division unit 120 may divide the plurality of items into N subsets according to usage frequencies of the respective items. In other words, the item division unit 120 may separate the plurality of items into different categories according to how often the items are used, selected, and/or desired by the user. N is an integer larger than 1 and may be a desired (and/or pre-set) fixed value or a value determined according to the number of the plurality of items or the usage frequency distribution of the plurality of items.

Specifically, the higher the usage frequency an item has, the smaller the subset the item belongs to. In other words, an item with a high usage frequency may be assigned to a small-sized subset, while an item with a low usage frequency may be assigned to a large-sized subset. Each of the subsets may be independent of each other, and it may be desirable to randomly select one item to illuminate one or more times from each of the subsets each time. Therefore, the item with a higher usage frequency may be flashed in a higher frequency so as to accelerate the recognition.

It is to be understood that as for the item division unit 120 dividing the respective items into the N subsets according to their usage frequencies, the item division unit 120 may perform the above division logically, rather than dividing the items in terms of their physical positions. In other words, the locations of the items in the BCI may be irrelevant to the division of the subsets. That is, the locations of the items in the BCI are not limited and may be changed flexibly so that additional convenience may be provided to the user and therefore the application range of the BCI technologies may be extended. For example, the BCI may be displayed in the form of a user-familiar virtual keyboard when the P300 component-based BCI technology is used for the purpose of facilitating a user's ability to type by allowing the user to input or select a character using the virtual keyboard. The P300 component-based BCI technology may also be applied to UI operation of an electrical device, for example allowing a user to control the operation of an electrical device by looking at various icons, shown on the UI, depicting the various actions that the electrical device may perform. The electrical device may be a robot, a motorized vehicle (such as a motorized wheelchair, or a car), a physical assistance device (such as a powered walking assistance apparatus, an electro-mechanical artificial appendage), or the like. For the operation of an electrical device, communications between the BCI and the electrical device may be established by wired and/or wireless means via a specialized interface which may accept inputs from the BCI apparatus and may transmit outputs to the BCI apparatus.

The flashing unit 130 causes N items in the BCI to illuminate one or more times in a desired (and/or predetermined) frequency so as to make the user aware of, or feel, flashing of the respective items, wherein one item may be randomly selected from each of the subsets to constitute the N items.

FIG. 2 illustrates a block diagram of the item division unit 120 according to an example embodiment. As illustrated in FIG. 2, the item division unit 120 may include a frequency table acquisition module 122 and a division module 124.

The frequency table acquisition module 122 may be used for acquiring a usage frequency table of the plurality of items where the plurality of items are ranked by the usage frequencies of the items in a descending order.

The usage frequency table may be obtained by counting the number of times that each of the items is used by the user, and an existing usage frequency table about the counted items may be obtained. For example, if the item to be selected is an English letter, the usage frequency table may be an existing letter usage frequency table counted based on English language materials.

As an example, in the case that the items to be selected are characters, the frequency table acquisition module 122 may acquire a usage frequency table corresponding to an input environment of the characters.

The input environment of the characters may support any language, and may include a Chinese input environment, an English input environment or the like. For example, if the input environment of the character is an English input environment, a usage frequency table of the letters for English input may be acquired. If the input environment of the character is a Chinese input environment, a usage frequency table of Bopomofo symbols for Chinese input may be acquired. Moreover, the usage condition may be further classified so that a usage frequency table for a specific usage condition may be acquired. For example, if the input environment of the character is to input the initial letter of an English word, a letter usage frequency table about the possibility distribution of occurrence of the initial letters of English words may be acquired. If the input environment of the character is to input another English letter after a certain English letter has been input, a letter usage frequency table about the possibility distribution that which English letter shall follow the certain English letter may be acquired.

The division module 124 may divide the plurality of items into a first through N-th subsets in turn according to a ranking in the usage frequency table, wherein each subset has an increasing size from the first subset to the N-th subset.

Specifically, the i-th subset may include Mᵢ items. Mᵢ is an integer larger than 1 which refers to the size of the i-th subset wherein i=1, . . . , N. From the first subset to the N-th subset, Mᵢ (i.e., the size) becomes increasingly large. Mᵢ may be a desired (and/or pre-set) fixed value or a value determined according to the number of the plurality of items or the usage frequency distribution of the plurality of items, the value of N or the like. After the values of Mᵢ are all determined, the division module 124 may assign the first M₁ items in the usage frequency table into the first subset, may assign the first M₂ items among the remaining items in the usage frequency table into the second subset, and so on.

A variety of related usage frequency tables may be used when dividing the items by using a usage frequency table, for example, a general usage frequency table based on a large number of statistical samples, or a personalized usage frequency table based on a user's usage pattern. Accordingly, the item selected by the user may be recognized more quickly through the proper division of the items based on the usage frequencies of the items in the usage frequency table.

FIG. 3 illustrates a block diagram of the flashing unit 130 according to an example embodiment. According to an example embodiment, the flashing unit 130 may include an item selection module 132 and an illuminating module 134.

The item selection module may randomly select one item from the each of the first through N-th subsets to constitute the N items for each illumination, wherein an item selected from the i-th subset each time may be different from one another for Mᵢ selections performed since an item is selected from the i-th subset for a first time.

The illuminating module may cause the N items selected by the item selection module in the BCI to illuminate each time in the desired (and/or predetermined) frequency so as to make the user aware of, or feel, the flashing of the respective items.

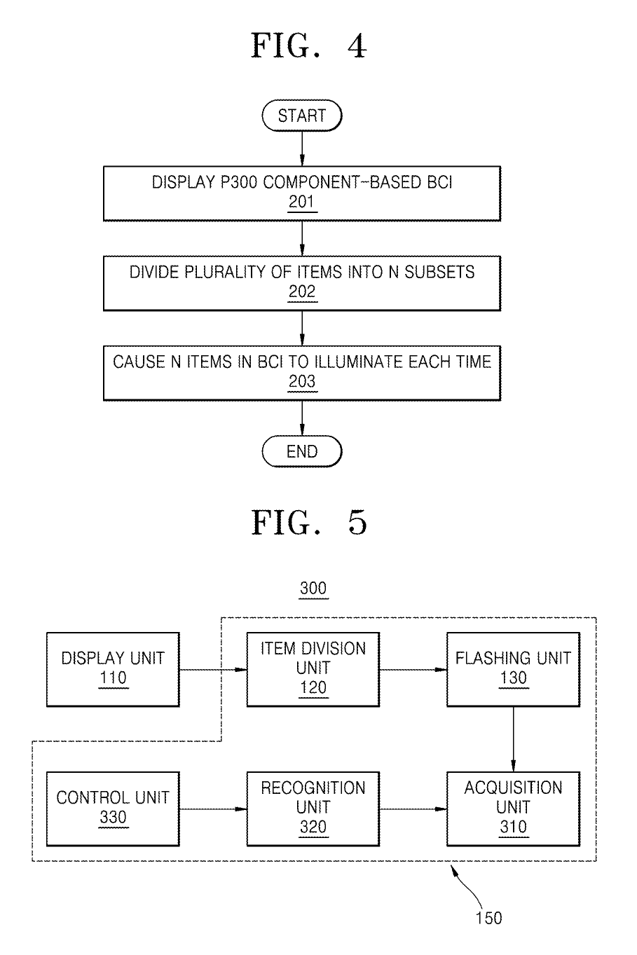

FIG. 4 illustrates a flow diagram of a method for implementing a P300 component-based BCI according to an example embodiment.

As illustrated in FIG. 4, at step 201, the P300 component-based BCI, which includes a plurality of items to be selected, may be displayed to a user.

The P300 component-based BCI may be displayed to the user through a screen, or the like. The user may select one item from the BCI by watching the item. The item may be a character, an icon, a thumbnail or the like. For example, the BCI may be a virtual keyboard interface including a plurality of characters, a user interface (UI) including a plurality of application icons, or the like.

At step 202, the plurality of items included in the BCI may be divided into N subsets according to the usage frequencies of the respective items. N is an integer larger than 1, wherein the higher the usage frequency an item has, the smaller subset the item may belong to. In other words, an item with a high usage frequency may be assigned to a small-sized subset, while an item with a low usage frequency may be assigned to a large-sized subset. Each of the subsets may be independent of each other, and it may be desirable to randomly select one item to illuminate from each of the subsets each time. Therefore, the item with the higher usage frequency may be flashed in a higher frequency so as to accelerate the recognition.

It is to be understood that when dividing the respective items into the N subsets according to their usage frequencies, the above division may be performed logically, rather than dividing the items in terms of their physical positions. In other words, the locations of the items in the BCI may be irrelevant to the division of the subsets. That is, the locations of the items in the BCI are not limited and may be changed flexibly so that additional convenience may be provided to the user and the application range of the BCI technology may be extended. For example, the BCI may be displayed in the form of a user-familiar virtual keyboard when the P300 component-based BCI technology are applied for inputting a character, so as to facilitate the selection by the user. The P300 component-based BCI technologies may also be applied to UI operation of an electrical device.

As an example, the plurality of items may be divided into N subsets according to their usage frequencies as follows: the usage frequency table of the plurality of items, where the plurality of items are ranked by the usage frequencies of the items in a descending order, may be acquired first.

The usage frequency table may be obtained by counting the number of times that each of the items is used by the user, and an existing usage frequency table about the counted items may be obtained. For example, if the item to be selected is an English letter, the usage frequency table may be an existing letter usage frequency table counted based on English language materials.

As an example, in the case that the items to be selected are characters, the acquired usage frequency table may correspond to an input environment of the characters. The input environment of the character may be a Chinese input environment, an English input environment or the like.

For example, if the input environment of the character is an English input environment, a usage frequency table of the letters for English input may be acquired. If the input environment of the character is a Chinese input environment, a usage frequency table of Bopomofo symbols for Chinese input may be acquired. Moreover, the usage condition may be further classified so that a usage frequency table for a specific usage condition may be acquired. For example, if the input environment of the character is to input the initial letter of an English word, a letter usage frequency table about the possibility distribution of occurrence of the initial letters of English words may be acquired. If the input environment of the character is to input another English letter after a certain English letter has been input, a letter usage frequency table about the possibility distribution that which English letter shall follow the certain English letter may be acquired.

Thereafter, the plurality of items may be divided into a first through N-th subsets in turn according to a ranking in the usage frequency table, wherein each subset has an increasing size from the first subset to the N-th subset.

Specifically, the i-th subset may include Mᵢ items. Mᵢ may be an integer larger than 1 which may refer to the size of the i-th subset wherein i=1, . . . , N. From the first subset to the N-th subset, Mᵢ (i.e., the size) may become increasingly large. Mᵢ may be a desired (and/or pre-set) fixed value or a value determined according to the number of the plurality of items or the usage frequency distribution of the plurality of items, the value of N or the like. After the values of Mᵢ are all determined, the first M₁ items in the usage frequency table may be assigned to the first subset, the first M₂ items among the remaining items in the usage frequency table may be assigned to the second subset and so on.

A variety of related usage frequency tables may be used when dividing the items by using a usage frequency table, for example, a general usage frequency table based on a large number of statistical samples or a personalized usage frequency table based on a user's usage pattern. Accordingly, the item selected by the user may be recognized more quickly through the proper division based on the usage frequencies of the items in the usage frequency table.

At step 203, the N items in the BCI may be caused to illuminate each time in a desired (and/or predetermined) frequency so as to make the user aware of, or feel, flashing of the respective items, wherein one item is randomly selected from each of the subsets to constitute the N items.

As an example, firstly, one item may be randomly selected from the each of the first through N-th subsets to constitute the N items for each illumination, wherein an item selected from the i-th subset each time may be different from one another for Mᵢ selections performed since an item is selected from the i-th subset for a first time.

Thereafter, the selected N items in the BCI may be caused to illuminate each time in the desired (and/or predetermined) frequency so as to make the user aware of, or feel, the flashing of the respective items.

FIG. 5 illustrates a block diagram of an apparatus for a P300 component-based BCI according to an example embodiment. Here, as an example, the apparatus may be a mobile communication terminal, a personal PC, a tablet PC, a game console, a TV, or the like.

The apparatus 300 for the P300 component-based BCI according to an example embodiment may include a display unit 110 and a processor 150. The processor 150 may include an item division unit 120, a flashing unit 130, an acquisition unit 310, a recognition unit 320, and a control unit 330. Alternatively, the item division unit 120, the flashing unit 130, the acquisition unit 310, the recognition unit 320, and/or the control unit 330 may be implemented as specialized hardware devices that communicatively connected to the processor 150, such as by a communication bus or a wireless connection. Here, the display unit 110, the item division unit 120 and the flashing unit 130 may be constructed in a similar manner as described referring to FIG. 1. While only one processor is illustrated in FIG. 5, the apparatus 300 is not limited thereto, and may include a plurality of processors and one or more data storage devices (not shown). The one or more processors may be special purpose computer processing devices configured to carry out program code stored in the one or more storage devices by performing arithmetical, logical, and input/output operations. For example, program code, software units, and/or software modules may be loaded into the one or more processors. Once the program code and/or software modules are loaded into the one or more processors, the one or more processors may be configured to perform operations according to various example embodiments.

The one or more storage devices may be a computer readable storage medium that generally includes a random access memory (RAM), read only memory (ROM), a permanent mass storage device (such as a disk drive), and/or any other like data storage mechanism capable of storing and recording data. The one or more storage devices may be configured to store program code for one or more operating systems and/or program code for one or more software components and/or modules for performing operations according to various example embodiments. These software components may also be loaded from a separate computer readable storage medium into the one or more storage devices and/or the one or more processors using a drive mechanism (not shown). Such separate computer readable storage medium may include memory card, removable flash memory drive, and/or other like computer readable storage medium (not shown). In some embodiments, software components may be loaded into the one or more storage devices and/or the one or more processors from a remote data storage device via a network interface, rather than via a computer readable storage medium.

Specifically, the display unit 110 may be used for displaying to a user the P300 component-based BCI, which may include a plurality of items.

The item division unit 120 may divide the plurality of items into N subsets according to the usage frequencies of respective items, wherein N is an integer larger than 1, wherein the higher the usage frequency the item has, the smaller subset the item belongs to.

The flashing unit 130 may cause N items in the BCI to illuminate each time in a desired (and/or predetermined) frequency so as to make the user aware of, or feel, flashing of the respective items, wherein one item may be randomly selected from each of the subsets to constitute the N items.

The acquisition unit 310 may acquire an EEG signal of the user collected with respect to each flashing.

Specifically, the acquisition unit 310 may acquire the collected EEG signal of the user from an apparatus (e.g., a headcap EEG electrode kit) for collecting the EEG signal of the user. After each flashing, the acquisition unit 310 may acquire the EEG signal of the user collected with respect to this time of flashing from the apparatus for collecting the EEG signal of the user. Alternatively, after a desired (and/or predetermined) times of flashing, the acquisition unit 310 may acquire the EEG signals of the user collected with respect to the desired (and/or predetermined) times of flashing from the apparatus for collecting the EEG signal of the user, and then acquire the EEG signal of the user corresponding to each flashing among the desired (and/or predetermined) times of flashing.

The recognition unit 320 may recognize the item which the user desires to select based on the P300 component in the acquired EEG signal.

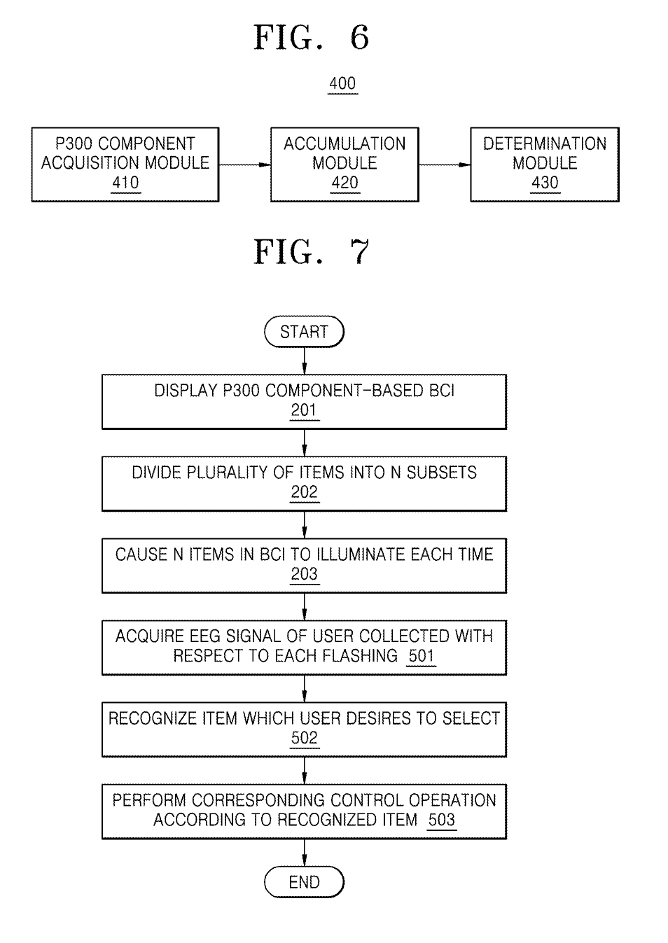

Specifically, the recognition unit 320 may recognize the item which the user desires to select (i.e., the item on the BCI being watched by the user) based on the P300 component in the EEG signal with respect to each flashing. The recognition unit 320 may recognize the item which the user desires to select based on the P300 component in the acquired EEG signal through the utilization of various technologies. Hereinafter, an example embodiment of the structure of the recognition unit 320 will be described with reference to FIG. 6.

The control unit 330 may perform a corresponding control operation according to the recognized item.

The control operation may be to input a content corresponding to the recognized item, to execute an application corresponding to the recognized item, to perform a process corresponding to the recognized item, or the like. For example, if the item is a character, the control operation may be to input the recognized character. If the item is an icon, the control operation may be to execute an application corresponding to the recognized icon or to perform a process corresponding to the recognized icon.

In an example embodiment, the apparatus 300 for the P300 component-based BCI may include an updating unit (not shown).

The updating unit may update the usage frequencies of the respective items based on the item recognized by the recognition unit 320.

Specifically, the updating unit may update the number of the usage times of the item recognized by the recognition unit 320 based on the recognized item, and update the usage frequencies of the respective items.

The updating unit may update the usage frequencies of the respective items after each time the item which the user desires to select is recognized by the recognition unit 320. Alternatively, the updating unit may update the usage frequencies of the respective items based on the items recognized by the recognition unit 320 in a desired (and/or predetermined) time interval. Through the manners described above, the usage frequencies of the items may be adjusted timely so that the usage frequencies of the items may further accord with user's usage pattern and provide an improved or more accurate basis for the division of the items.

The updating unit may determine which manner should be used for updating the usage frequencies of the respective items according to performance of the apparatus 300 for the P300 component-based BCI, user settings, and the like. For example, when the performance of the apparatus is high, the usage frequencies of the respective items may be updated after each time the item which the user desires to select is recognized by the recognition unit 320. In the case that the usage frequencies of the respective items may be updated based on the items recognized by the recognition unit 320 in a desired (and/or predetermined) time interval, the requirement for the performance of the apparatus would be lower.

FIG. 6 illustrates a block diagram of a recognition unit according to an example embodiment.

As illustrated in FIG. 6, the recognition unit 320 may include a P300 component acquisition module 410, an accumulation module 420, and a determination module 430.

The P300 component acquisition module 410 may acquire the P300 component in the EEG signal of the user collected with respect to each flashing.

The P300 components acquisition module 410 may acquire the P300 component in the EEG signal of the user collected with respect to each flashing through the utilization of various technologies, such as computer technologies.

The accumulation module 420 may accumulate the P300 component collected with respect to the each flashing to the P300 components corresponding to the respective items which are caused to illuminate for said each flashing.

Specifically, the flashing unit 130 may cause the N items in the BCI to illuminate each time so as to make the user aware of, or feel, flashing of the respective items. The accumulation module 420 may accumulate the P300 component collected with respect to the each flashing to the P300 components corresponding to the respective items which are caused to illuminate for said each flashing.

The determination module 430 may determine the item corresponding to a largest accumulated P300 component as the item which the user desires to select.

Specifically, when one item corresponds to the largest P300 component, that is, when the one item corresponds to the largest P300 component and the difference between the largest P300 component and the P300 components corresponding to each of the other items exceeds a certain value, the one item may be determined as the item which the user desires to select.

FIG. 7 illustrates a flow diagram of a method for a P300 component-based BCI according to an example embodiment. Here, steps 201, 202, and 203 may be implemented in a similar manner as described referring to FIG. 4.

Specifically, at step 201, the P300 component-based BCI may be displayed to a user. Specifically, the BCI may include a plurality of items to be selected. N may be an integer larger than 1.

At step 202, the plurality of items included in the BCI may be divided into N subsets according to usage frequencies of the respective items. The higher usage frequency an item has the smaller subset the item belongs to.

At step 203, the N items in the BCI may be caused to illuminate each time in a desired (and/or predetermined) frequency so as to make the user aware of, or feel, flashing of the respective items, wherein one item is randomly selected from each of the subsets to constitute the N items.

At step 501, an electroencephalogram (EEG) signal of the user collected with respect to each flashing may be acquired.

Specifically, the collected EEG signal of the user may be acquired from an apparatus (e.g., headcap EEG electrode kit) for collecting the EEG signal of the user. After each flashing, the EEG signal of the user collected with respect to this time of flashing may be acquired from the apparatus for collecting the EEG signal of the user. Alternatively, after a desired (and/or predetermined) times of flashing, the EEG signals of the user collected with respect to the desired (and/or predetermined) times of flashing may be acquired from the apparatus for collecting the EEG signal of the user, and then the EEG signal of the user corresponding to each flashing among the desired (and/or predetermined) times of flashing may be acquired.

At step 502, the item which the user desires to select may be recognized based on the P300 component in the acquired EEG signal.

Specifically, the item which the user desires to select (i.e., the item on the BCI being watched by the user) may be recognized based on the P300 component in the EEG signal with respect to each flashing.

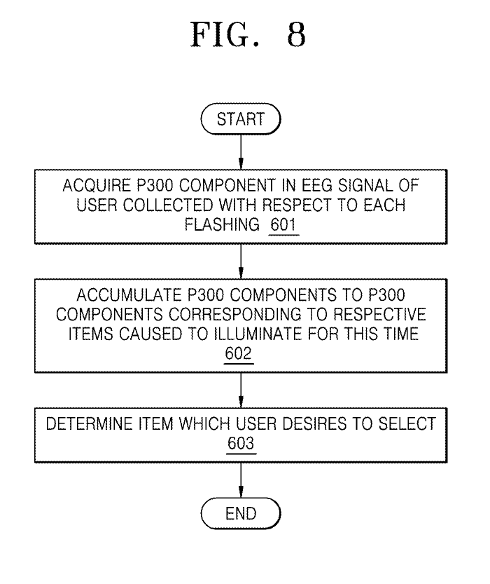

The item which the user desires to select may be recognized based on the P300 component in the acquired EEG signal through the utilization of various technologies. The method as illustrated in FIG. 8 may be performed to recognize the item which the user desires to select based on the P300 component in the acquired EEG signal.

At step 503, a corresponding control operation may be performed according to the recognized item. The control operation may be to input a content corresponding to the recognized item, to execute a function corresponding to the recognized item, to perform a process corresponding to the recognized item, or the like. For example, if the item is a character, the control operation may be to input the recognized character. If the item is an icon, the control operation may be to execute an application corresponding to the recognized icon or to perform a process corresponding to the recognized icon.

As an example, the method for the P300 component-based BCI may further include updating the usage frequencies of the respective items based on the recognized item.

The usage frequencies of the respective items may be updated after each time the item which the user desires to select is recognized. Alternatively, the updating the usage frequencies of the respective items may be updated based on the recognized items in a desired (and/or alternatively predetermined) time interval. Through the manners described above, the usage frequencies of the items may be adjusted timely so that the usage frequencies of the items may further accord with user's usage pattern and provide a more accurate basis for the division of the items.

FIG. 8 illustrates a flow diagram of a method for recognizing an item which the user desires to select based on a P300 component in an acquired EEG signal according to an example embodiment. The method of FIG. 8 may be performed when performing step 502 of FIG. 7.

As illustrated in FIG. 8, at step 601, the P300 component in the EEG signal of the user may be collected with respect to each flashing may be acquired. The P300 component in the EEG signal of the user may be collected with respect to each flashing may be acquired through the utilization of various technologies, such as computer technology.

At step 602, the P300 component collected with respect to the each flashing may be accumulated to the P300 components corresponding to the respective items which are caused to illuminate for said each flashing.

At step 603, the item corresponding to a largest accumulated P300 component may be determined as the item which the user desires to select.

Specifically, when one item obviously corresponds to the largest P300 component, that is, when the one item corresponds to the largest P300 component and the difference between the largest P300 component and the P300 components corresponding to each of the other items exceeds a certain value, the one item may be determined as the item which the user desires to select.

The apparatus and method for implementing a P300 component-based BCI according to the example embodiments may shorten recognition time, improve recognition speed and extend the application range of the BCI technologies.

Furthermore, the above methods according to the example embodiment may be implemented as computer programs that, when executed, implement the above methods. Each of the units in the apparatus according to an example embodiment may be implemented as a hardware component.

The units and/or modules described herein may be implemented using hardware components, software components, or a combination thereof. For example, the hardware components may include processing devices and display panels. A processing device may be implemented using one or more hardware devices configured to carry out and/or execute program code by performing arithmetical, logical, and input/output operations. The processing device(s) may include a processor, a controller and an arithmetic logic unit, a digital signal processor, a microcomputer, a field programmable array, an application specific integrated circuit, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, or computer storage medium or device capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, and hardware devices that are specially configured to store and perform program instructions, such as read-only memory (ROM), random access memory (RAM), flash memory (e.g., USB flash drives, memory cards, memory sticks, etc.), three-dimensional memory arrays, and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

1. An apparatus for implementing a P300 component-based brain-computer interface (BCI), comprising:
a display unit configured to display to a user a P300 component-based BCI, which includes a plurality of items to be selected;
an item division unit configured to divide the plurality of items into at least two N subsets according to usage frequencies of each of the plurality of items, wherein a higher usage frequency the item has, a smaller subset to which the item belongs; and
a flashing unit configured to cause N items in the BCI to illuminate in accordance with a desired frequency in order to cause at least one flashing of the N items, and
the flashing unit configured to randomly select a respective item from each of the N subsets to constitute the N items.

2. The apparatus of claim 1, wherein the randomly selected items are at least one of a character, icon and thumbnail.

3. The apparatus of claim 1, wherein the item division unit comprises:
a frequency table acquisition module configured to acquire a usage frequency table of the plurality of items where the plurality of items are ranked based on the usage frequencies of the N items in a descending order; and
a division module configured to divide the plurality of items into a first through N-th subsets in turn according to a ranking in the usage frequency table, wherein each subset of the first through N-th subsets contains the same or greater number of items as the previous subset.

4. The apparatus of claim 3, wherein the items to be selected are characters and the frequency table acquisition module is configured to acquire a usage frequency table corresponding to an input environment of the characters.

5. The apparatus of claim 1, wherein the flashing unit comprises:
an item selection module configured to randomly select the respective item from each of the first through N-th subsets to constitute the N items for illumination,
wherein an i-th subset is one of the first through N-th subsets, wherein i=1, . . . , N, and the i-th subset is composed of Mᵢ items, and wherein Mᵢ is an integer larger than 1,
wherein an item selected from the i-th subset is different each time for each Mᵢ selection performed since the item is selected from the i-th subset for a first time; and
an illuminating module configured to cause the N items selected by the item selection module in the BCI to illuminate in accordance with a desired frequency so as to cause the at least one flashing of the N items.

6. The apparatus of claim 1, comprising:
an acquisition unit configured to acquire an electroencephalogram (EEG) signal of the user in response to each flashing;
a recognition unit configured to recognize the item which the user desires to select, based on the P300 component in the acquired EEG signal; and
a control unit configured to perform a corresponding control operation according to the recognized item.

7. The apparatus of claim 6, wherein the recognition unit comprises:
a P300 component acquisition module configured to acquire the P300 component in the EEG signal of the user in response to each flashing;
an accumulation module configured to accumulate the P300 component collected with respect to the each flashing, the P300 components corresponding to the N items that were flashing; and
a determination module configured to determine one item of the N items that were flashing as corresponding to a largest accumulated P300 component, and
in accordance with the determining, recognizing the one item of the N items that were flashing as the item which the user desires to select.

8. The apparatus of claim 6, including an updating unit configured to update the usage frequencies of the respective items based on the recognized item.

9. The apparatus of claim 6, wherein the control operation comprises at least one of inputting a content corresponding to the recognized item, executing an application corresponding to the recognized item, and performing a process corresponding to the recognized item.

10.-15. (canceled)

16. A brain-computer interface (BCI) system comprising:
an electroencephalography (EEG) collection device connected to a user, the EEG collection device configured to collect EEG signals produced by the user;
a display configured to display images to a user using a display panel, the images corresponding to a user interface environment; and
a processor configured to separate the images into a plurality of categories, present at least one image from each of the plurality of categories to the user on the display panel, and to cause the presented images to flash, and
the processor is configured to determine the image that the user has selected based on the collected EEG signals after the flashing unit has presented the at least one image to the user, and perform an action based on the image that the user has selected.

17. The system of claim 16, wherein the user interface environment corresponds to a virtual keyboard for a language and the images correspond to characters of the language.

18. The system of claim 16, wherein the user interface environment corresponds to a plurality of programs that the processor is configured to execute and the images correspond to icons for the plurality of programs.

19. The system of claim 16, wherein the user interface environment corresponds to a user interface for control of an electrical device and the images correspond to actions that the electrical device is configured to perform.
